(19) United States
(12) Patent Application Publication
(10) Pub. No.: US 2025/0272862 A1
(43) Pub. Date: Aug. 28, 2025

(54) FACILITATING GENERATION OF A POINT CLOUD WITH IMPROVED MEASUREMENT PRECISION

(71) Applicant: Lumentum Operations LLC, San Jose, CA (US)

(72) Inventors: Daniel BURKE, Vars (CA); Alan HNATIW, Stittsville (CA)

(21) Appl. No.: 18/628,216

(22) Filed: Apr. 5, 2024

Related U.S. Application Data
(60) Provisional application No. 63/558,865, filed on Feb. 28, 2024.

(51) Int. Cl. G06T 7/50; G01S 17/89; G06T 11/60; G06T 17/00

(52) U.S. Cl. CPC G06T 7/50; G01S 17/89; G06T 11/60; G06T 17/00; G06T 2207/10028

(57) ABSTRACT

A metrology system may generate, using a first frequency, a first point cloud associated with a region of an object and may identify a particular distance measurement associated with a particular point of the first point cloud. The metrology system may generate, using a second frequency that is greater than the first frequency, a second point cloud associated with the region of the object. The metrology system may determine one or more relative depth measurements from the particular point of the first point cloud to one or more points of the second point cloud, respectively. The metrology system may thereby generate a third point cloud associated with the region of the object to include one or more points that correspond to the one or more points of the second point cloud and that indicate the one or more relative depth measurements, respectively.

### CROSS-REFERENCE TO RELATED APPLICATION

This Patent application claims priority to U.S. Patent Application No. 63/558,865, filed on Feb. 28, 2024, and entitled “POINT CLOUD PHASE UNWRAPPING USING LOCAL POINTS.” The disclosure of the prior Application is considered part of and is incorporated by reference into this Patent Application.

### TECHNICAL FIELD

The present disclosure relates generally to generation of a point cloud, and to facilitating generation of a point cloud with improved measurement precision.

### BACKGROUND

A point cloud is a collection of data points in three-dimensional space. Each point in the cloud represents a coordinate, such as in reference to X, Y, and Z axes, and thereby defines a precise position in space.

### SUMMARY

In some implementations, a method includes generating, by a metrology system and using a first frequency, a first point cloud associated with a region of an object, wherein each point of the first point cloud indicates a distance measurement from a portion of the region of the object to an optical sensor of the metrology system; identifying, by the metrology system, a particular distance measurement associated with a particular point of the first point cloud; generating, by the metrology system and using a second frequency that is greater than the first frequency, a second point cloud associated with the region of the object, wherein each point of the second point cloud indicates a distance measurement from a portion of the region of the object to the optical sensor of the metrology system; determining, by the metrology system and based on the particular distance measurement associated with the particular point of the first point cloud, one or more relative depth measurements from the particular point of the first point cloud to one or more points of the second point cloud, respectively; generating, by the metrology system and based on the one or more relative depth measurements, a third point cloud associated with the region of the object to include one or more points that correspond to the one or more points of the second point cloud and that indicate the one or more relative depth measurements, respectively; and performing, by the metrology system and based on the third point cloud, one or more actions.

In some implementations, a metrology system includes one or more memories; and one or more processors, coupled to the one or more memories, configured to: generate, based on the metrology system using a first frequency, a first point cloud associated with a region of an object; identify a particular distance measurement associated with a particular point of the first point cloud; generate, based on the metrology system using a second frequency that is greater than the first frequency, a second point cloud associated with the region of the object, determine, based on the particular distance measurement associated with the particular point of the first point cloud, one or more relative depth measurements from the particular point of the first point cloud to one or more points of the second point cloud, respectively; and generate, based on the one or more relative depth measurements, a third point cloud associated with the region of the object to include one or more points that correspond to the one or more points of the second point cloud and that indicate the one or more relative depth measurements, respectively.

In some implementations, a non-transitory computer-readable medium storing a set of instructions includes one or more instructions that, when executed by one or more processors of a metrology system, cause the metrology system to: generate, based on the metrology system using a first frequency, a first point cloud associated with a region of an object, generate, based on the metrology system using a second frequency that is greater than the first frequency, a second point cloud associated with the region of the object, determine, based on a particular distance measurement associated with a particular point of the first point cloud, one or more relative depth measurements from the particular point of the first point cloud to one or more points of the second point cloud, respectively; and generate, based on the one or more relative depth measurements, a third point cloud associated with the region of the object to include one or more points that correspond to the one or more points of the second point cloud and that indicate the one or more relative depth measurements, respectively.

### BRIEF DESCRIPTION OF THE DRAWINGS

FIGS. 1A-1F are diagrams of an example implementation associated with facilitating generation of a point cloud with improved measurement precision.

FIG. 2 is a diagram of an example environment in which systems and/or methods described herein may be implemented.

FIG. 3 is a diagram of example components of a device associated with determining an optimal configuration for a metrology system.

FIG. 4 is a flowchart of an example process associated with facilitating generation of a point cloud with improved measurement precision.

### DETAILED DESCRIPTION

The following detailed description of example implementations refers to the accompanying drawings. The same reference numbers in different drawings may identify the same or similar elements.

A metrology system can utilize an optical sensor to measure an object, which allows the metrology system to generate a point cloud associated with the object (e.g., that indicates a geometry of the object). The object should be positioned within an unambiguous range of the optical sensor (e.g., a range of distances, from the optical sensor, at which the optical sensor is able to accurately measure distances) to enable the metrology system to accurately measure the object. Further, due to the periodic nature of a frequency used by the optical sensor, the optical sensor can support a plurality of fringes (e.g., that are associated with a period of the frequency) that extend out end-to-end from the optical sensor, where one fringe is equal to a maximum distance of the unambiguous range. Accordingly, when the object is positioned within the unambiguous range, the object is positioned within a first fringe of the optical sensor. When the object is positioned outside the unambiguous range, the object is positioned in another (e.g., a second, a third, a fourth, and so on) fringe of the optical sensor, but the optical sensor is only able to measure the object with reference to a starting position of the other fringe, and is not able to determine which fringe the object is within. In this way, positioning the object within the first fringe (e.g., the unambiguous range) of the optical sensor is often preferred to obtain actual measurements of the object (e.g., actual distances from the optical sensor to the object).

Generally, the farther away an object is from the optical sensor of the metrology system, the lower the frequency needs to be (e.g., that is used by the optical sensor) for the object to be within the unambiguous range of the optical sensor (e.g., within the first fringe). However, decreasing the frequency results in a decrease of measurement precision of the object (e.g., in terms of accuracy and/or resolution), which is then represented in the point cloud generated by the metrology system.

In some cases, such as when the optical sensor supports using multiple frequencies to measure an object (e.g., the optical sensor is a phase-based multi-tone continuous wave (PB-MTCW) optical sensor, or another type of multi-tone optical sensor), the optical sensor may use a higher frequency to (also) measure the object (e.g., because the higher frequency enables an increased measurement precision of the object). However, the object then may not be within the unambiguous range of the optical sensor (e.g., which has been decreased because the frequency is higher). For example, the object may be within a second fringe, a third fringe, or another fringe that is not the first fringe. Accordingly, the metrology system may generate a point cloud that represents distance measurements from the object to a starting point of the fringe within which the object is positioned. Consequently, the metrology system is not able to determine how many fringes separate the object and the optical sensor and therefore an actual distance to the object is not represented in the point cloud.

Some implementations described herein include a metrology system. The metrology system (e.g., an optical sensor of the metrology system) uses a first frequency to generate a first point cloud associated with a region of an object, and uses a second frequency to generate a second point cloud associated with the region of the object. In some implementations, the second frequency is greater than the first frequency, and therefore the first point cloud may be “coarse” (e.g., indicate less precise distance measurements associated with the region of the object) and the second point cloud may be “fine” (e.g., indicate more precise distance measurements associated with the region of the object).

In some implementations, the region of the object is farther away from the metrology system than an unambiguous range (e.g., a first fringe) associated with the second frequency. Therefore, the points of the second point cloud indicate distance measurements with respect to the fringe within which the region of the object is positioned, but do not indicate actual distance measurements between the region of the object and the metrology system. Accordingly, the metrology system selects a point from the first point cloud (e.g., associated with a flat portion of the region of the object) and uses it as a reference point. The metrology system them selects points from the second point cloud that neighbor the reference point. Since the reference point is associated with a flat portion of the region of the object, the metrology system is able to determine a relative depth (e.g., a distance from the reference point) of each of the points from the second point cloud (based on a distance measurement associated with the fringe of the second frequency). The metrology system can then determine relative depths of the rest of the points in the second point cloud using a similar technique by selecting different reference points.

The metrology system then generates a “corrected” third point cloud that includes points that correspond to the points from the second point cloud, but with each point indicating a relative depth. This in turn makes the third point cloud more precise (e.g., in terms of accuracy and resolution) than the first (coarse) point cloud and allows for less ambiguity (e.g., by compensating for the points of the second point cloud not indicating actual distance measurements) than the second (fine) point cloud. In the context of indirect time of flight measurement scenarios, such as when an optical sensor of the metrology system is a PB-MTCW optical sensor, one or more operations described herein may be referred to as a “phase unwrapping” technique to generate the third point cloud.

Some implementations described herein enable the metrology system to sequentially use different frequencies to generate the first point cloud and the second point cloud (rather than attempting to measure the object with different frequencies during a same time period). Accordingly, for each frequency, the metrology system may allow more power to be utilized by the optical sensor to measure the object, which improves a quality of the distance measurements (e.g., with respect to signal-to-noise, or another quality parameter). Accordingly, the distance measurements associated with each point in the first cloud and the second cloud are of higher quality than would otherwise be possible using a measuring technique that utilizes multiple frequencies simultaneously. The higher quality of the first point cloud and the second point cloud therefore enable generation of a third point cloud with an improved precision (e.g., in terms of accuracy and/or resolution).

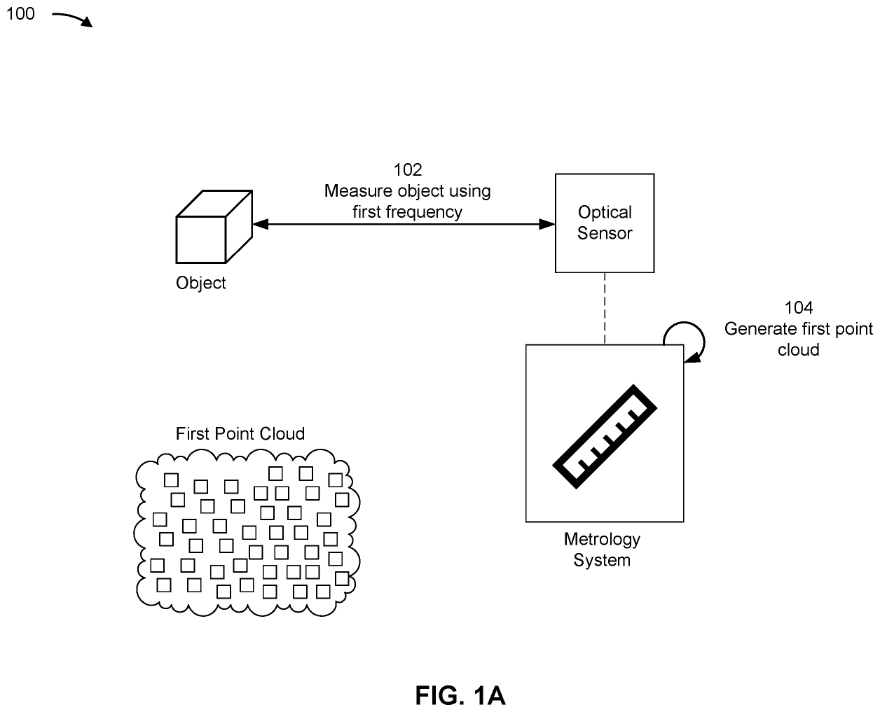

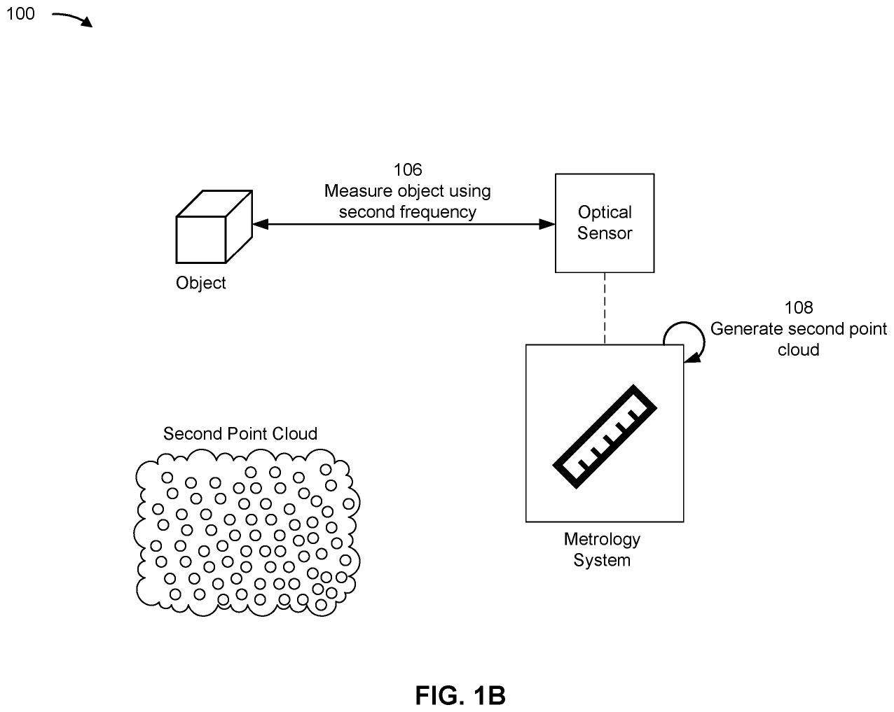

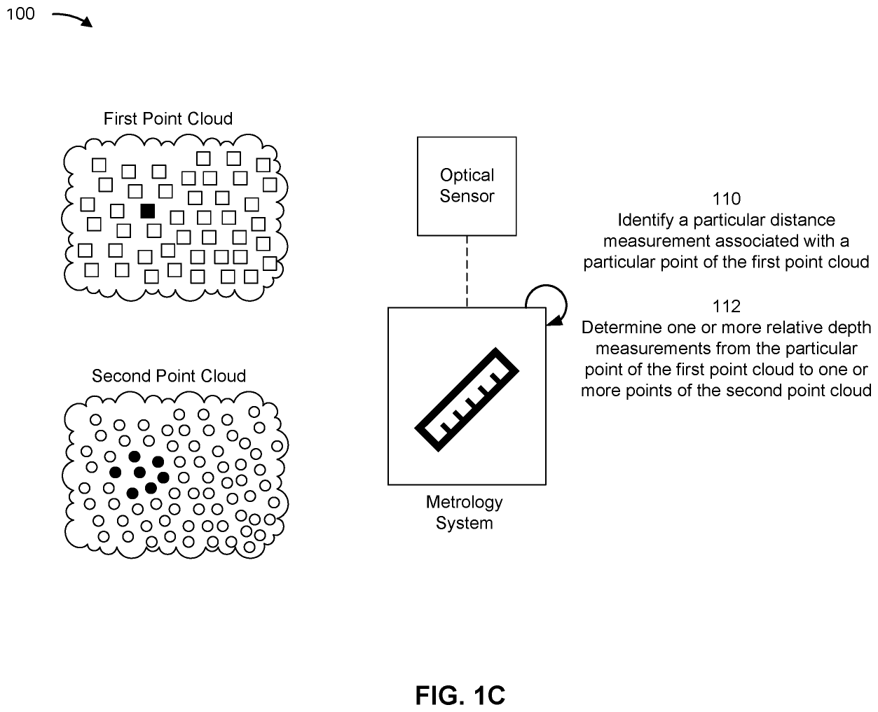

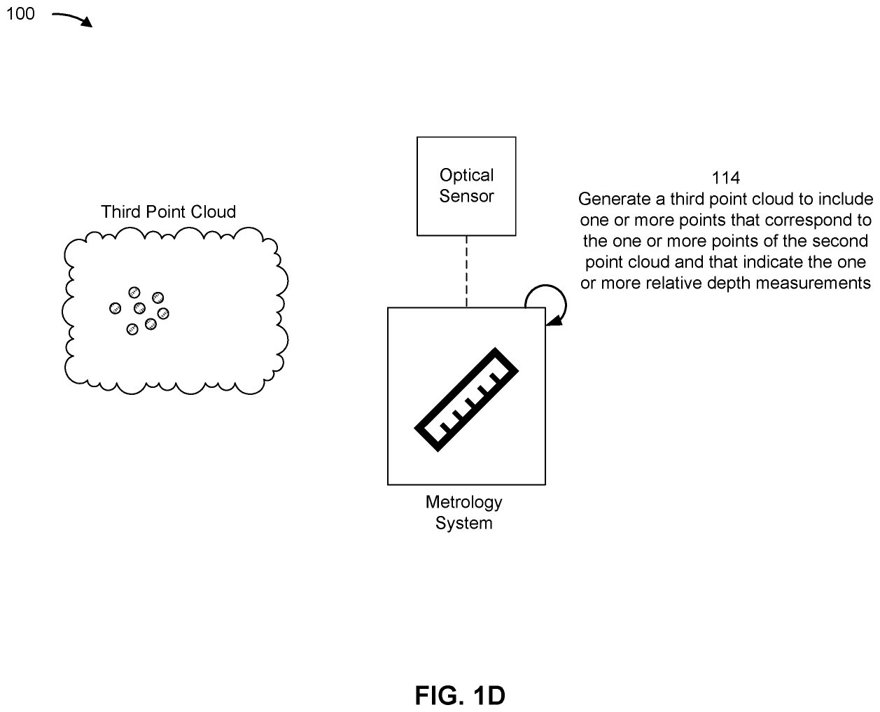

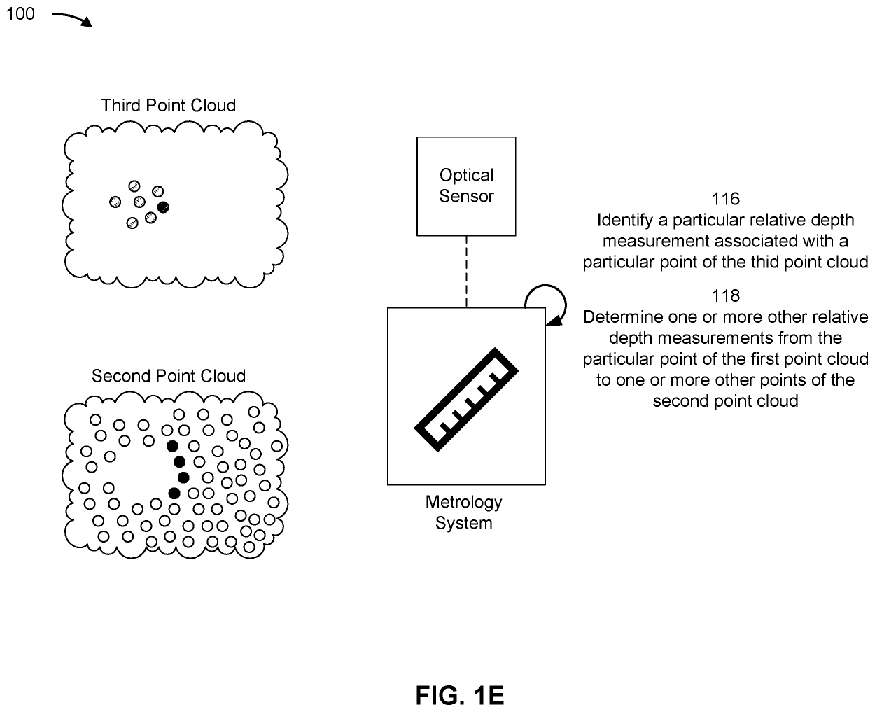

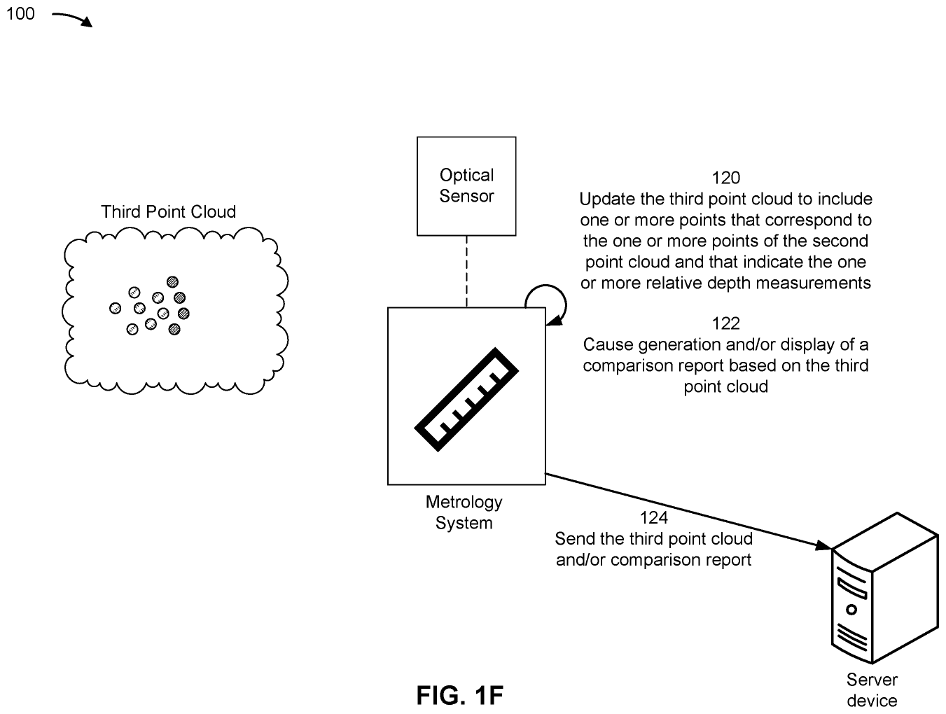

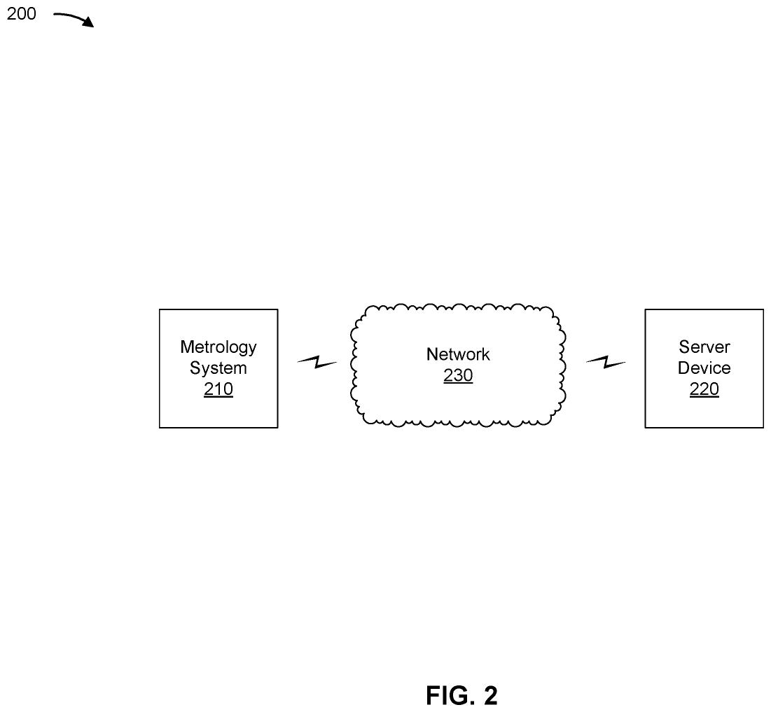

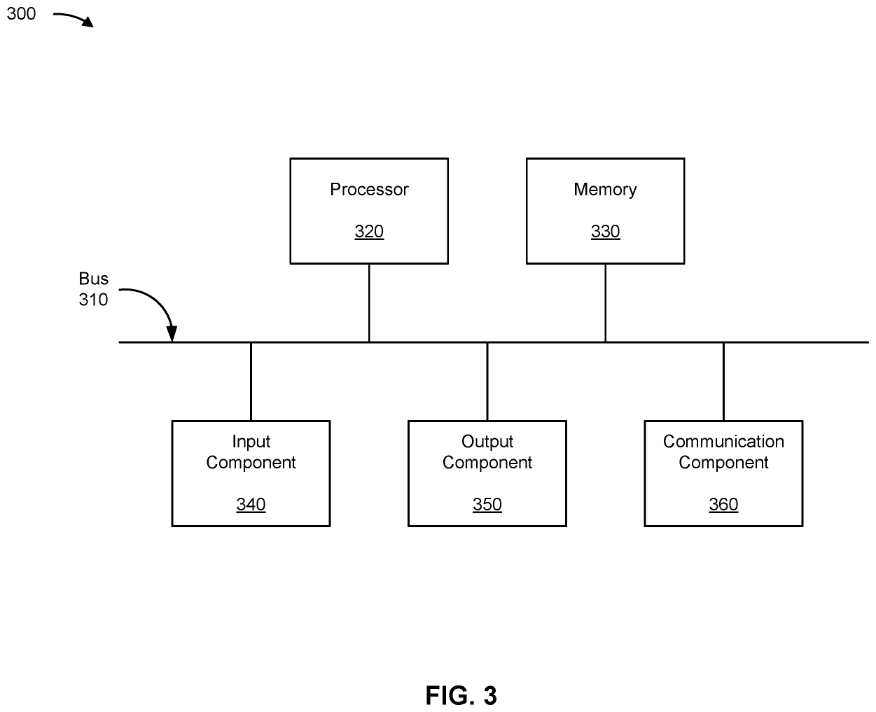

FIGS. 1A-1F are diagrams of an example implementation 100 associated with facilitating generation of a point cloud with improved measurement precision. As shown in FIGS. 1A-1F, example implementation 100 includes a metrology system and a server device. These devices are described in more detail below in connection with FIG. 2 and FIG. 3.

The metrology system may be used to measure an object (shown in FIGS. 1A and 1B) (e.g., measure a geometry of the object). The metrology system may be configured to include, for example, an optical sensor, such as a phase-based multi-tone continuous wave (PB-MTCW) optical sensor or an optical sensor associated with LiDAR (Light Detection and Ranging), photogrammetry, or other three-dimensional (3D) optical sensing technologies. The metrology system may include a frame, or other type of physical structure, on which the optical sensor is disposed (e.g., mounted on the frame). Accordingly, the metrology system may be configured to use the optical sensor to measure, using different frequencies, a region of the object and to thereby generate different point clouds associated with the region of the object, as further described herein.

As shown in FIG. 1A, and by reference number 102, the metrology system may measure the object using a first frequency. For example, the metrology system, using the optical sensor, may emit light associated with the first frequency at the object and may receive at least a portion of the light (e.g., as reflected light) to measure the object.

Accordingly, as shown by reference number 104, the metrology system may generate a first point cloud (e.g., by processing and/or analyzing reflected light associated with the first frequency). As shown in FIG. 1A, the first point cloud is represented as comprising a plurality of points, shown as squares. The first point cloud may be associated with a region of the object, such as a surface (or a portion of a surface) of the object that is within a field of view (FOV) of the optical sensor. Accordingly, each point of the first point cloud may indicate a distance measurement from a portion of the region of the object (e.g., a particular location of the region of the object) to the optical sensor of the metrology system.

As shown in FIG. 1B, and by reference number 106, the metrology system may measure the object using a second frequency. For example, the metrology system, using the optical sensor, may emit light associated with the second frequency at the object and may receive at least a portion of the light (e.g., as reflected light) to measure the object.

Accordingly, as shown by reference number 108, the metrology system may generate a second point cloud (e.g., by processing and/or analyzing reflected light associated with the second frequency). As shown in FIG. 1B, the second point cloud is represented as comprising a plurality of points, shown as circles. The second point cloud may be associated with the region of the object (e.g., the same region of the object as that discussed above with respect to FIG. 1A). Accordingly, each point of the second point cloud may indicate a distance measurement from a portion of the region of the object (e.g., a particular location of the region of the object) to the optical sensor of the metrology system.

In some implementations, the second frequency may be different than the first frequency. For example, the second frequency may be greater than the first frequency. That is, the second frequency may be “faster” than the first frequency. Accordingly, the first point cloud may represent “coarse” distance measurements and the second point cloud may represent “fine” distance measurements. That is, the distance measurements of the first point cloud may be less precise (e.g., may be less accurate and/or may have less resolution) as compared to the distance measurements of the second point cloud.

In some implementations, the first frequency may be associated with a first unambiguous range of the optical sensor of the metrology system and the second frequency may be associated with a second unambiguous range of the optical sensor. The first unambiguous range may include a range of distances, from the optical sensor, at which the optical sensor is able to accurately measure distances when measuring the object using the first frequency. The second unambiguous range may include a range of distances, from the optical sensor, at which the optical sensor is able to accurately measure distances when measuring the object using the second frequency. Accordingly, the first unambiguous range may be different than the second unambiguous range (e.g., when the first frequency and the second frequency are different). For example, the first unambiguous range may be greater than the second unambiguous range (e.g., when the second frequency is greater than the first frequency), such that a maximum distance associated with the first unambiguous range is greater than a maximum distance associated with the second unambiguous range.

In some implementations, the region of the object, when measured by the optical sensor using the first frequency, may be within the first unambiguous range of the optical sensor. Put another way, the region of the object may within a first fringe of the optical sensor that is associated with the first frequency. Accordingly, the points of the first point cloud may indicate actual distance measurements from the region of the object to the optical sensor. Additionally, the region of the object, when measured by the optical sensor using the second frequency, may not be within the second unambiguous range of the optical sensor (e.g., because the object is farther away than a maximum distance of the second unambiguous range of the optical sensor). Put another way, the region of the object may within a non-first fringe of the optical sensor that is associated with the second frequency. Accordingly, the points of the second point cloud may indicate distance measurements from the region of the object to a starting point of the non-first fringe within which the region of the object is positioned. For example, when the region of the object is within a K^{th} fringe of the optical sensor, the points of the second point cloud may indicate distance measurements relative to a starting point of the K^{th} fringe).

As shown in FIG. 1C, and by reference number 110, the metrology system may identify a particular distance measurement associated with a particular point of the first point cloud. For example, as shown in FIG. 1C, the metrology system may identify a particular distance measurement associated with a particular point, shown as a shaded square, of the plurality of points of the first point cloud that are shown as non-shaded squares. The particular point of the first point cloud may be associated with a sub-region of the region of the object (e.g., a particular location within the region of the object). Accordingly, in some implementations, the sub-region of the region of the object may be positioned within the first unambiguous range of the optical sensor (e.g., when the object was measured using the first frequency, as described herein in relation to FIG. 1A) and the particular distance measurement may indicate a distance from the sub-region of the region of the object to the optical sensor.

In some implementations, the metrology system may select the particular point of the first point cloud by performing one or more operations. For example, the metrology system may identify a plurality of sets of two or more adjacent points of the first point cloud. The metrology system then may determine a standard of deviation (or another statistical measurement) associated with respective distance measurements of the sets of two or more adjacent points. Accordingly, the metrology system may identify a particular set of two or more adjacent points that has a standard of deviation that is less than or equal to respective standards of deviation of one or more other sets of two or more adjacent points of the first point cloud. That is, the metrology system may select a particular set of two or more adjacent points that are associated with a “flattest” portion of the region of the object. The metrology system then may select, as the particular point of the first point cloud, a point (e.g., a “middle” point, or another point) from the particular set of two or more adjacent points. The particular distance measurement associated with the particular point may then be used as a “reference” distance measurement, as further described herein.

As shown by reference number 112, the metrology system may determine one or more relative depth measurements from the particular point of the first point cloud to one or more points of the second point cloud, respectively. That is, the particular distance measurement associated with the particular point of the first point cloud may be used as a reference distance measurement, and the metrology system may determine depth measurements of the one or more points of the second point cloud relative to the reference depth measurement.

The one or more points of the second point cloud may be associated with the sub-region of the region of the object (e.g., the same sub-region with which the particular point of the first point cloud is associated). That is, the one or more points of the second point cloud and the particular point of the first point cloud indicate distance measurements from the sub-region of the region of the object. In this way, the one or more points of the second point cloud and the particular point of the first point cloud represent “neighboring” points of the sub-region of the region of the object. For example, as shown in FIG. 1C, the particular point of the first point cloud, shown as a shaded square, is associated with a particular area of the first point cloud (e.g., that is associated with the sub-region of the region of the object) and the one or more points of the second point cloud, shown as shaded circles, are associated with a corresponding area of the second point cloud (e.g., that is associated with the sub-region of the region of the object).

In some implementations, a number of the one or more points of the second point cloud may satisfy (e.g., may be less than or equal to) a threshold. The threshold may be associated with enabling the metrology system to optimally (e.g., in terms of speed and accuracy, for example) determine relative depth measurements of the one or more points of the second point cloud. Accordingly, the threshold may be less than or equal to ten, fifteen, twenty, or twenty-five, or the threshold may be less than or equal to a percentage of points of the second point cloud, such as 0.1%, 0.5%, 1%, 2%, or 3% of the points of the second point cloud.

In some implementations, the metrology system may determine that a first point of the one or more points of the second point cloud that is “closest” to the particular point of the first point cloud (e.g., closest in a horizontal or a vertical direction) has a zero (0) depth, or substantially zero depth, relative to the particular point. The metrology system then may determine, based on the distance measurement associated with the first point (e.g., relative to a starting point of a fringe), the relative depth measurements of the other points of the one or more points of the second point cloud. For example, the metrology system, for a particular other point, may subtract the distance measurement associated with the first point from the distance measurement associated with the other point to determine the relative depth measurement for the other point. In this way, the metrology system may determine the one or more relative depth measurements of the one or more points of the second point cloud, respectively.

In some implementations, prior to the metrology system measuring the object using the second frequency (e.g., as described herein in relation to FIG. 1B), the metrology system may select the second frequency from a plurality of frequencies supported by the metrology system (e.g., a plurality of frequencies that may be used by the optical sensor of the metrology system). For example, the metrology system may obtain (e.g., from the server device, or another data source) 3D model information associated with the object, which may indicate a geometry of the object. The 3D model information may include a computer-aided design (CAD) model of the object, or another type of model of the object. Further, the metrology system may identify that the particular point of the first point cloud (e.g., as described herein in relation to FIG. 1C and reference number 110) is associated with the sub-region of the region of the object. Accordingly, the metrology system may determine (e.g., based on the 3D model information) an expected depth variation of the sub-region of the region of the object. The metrology system may therefore select, as the second frequency (e.g., for measuring the object and thereby generating the second point cloud, as described herein in relation to FIG. 1B) a frequency that is associated with an unambiguous range of the optical sensor that is greater than or equal to the expected depth variation of the sub-region of the object. In this way, the metrology system ensures that a relative depth measurement of a point of the second point cloud is within a fringe of the optical sensor (e.g., for the second frequency), which improves an accuracy of the relative depth measurement.

As shown in FIG. 1D, and by reference number 114, the metrology system may generate a third point cloud. The third point cloud may be associated with the region of the object (e.g., the same region of the object as that discussed above). In some implementations, the metrology system may generate the third point cloud to include one or more points that correspond to the one or more points of the second point cloud (e.g., that are described herein with respect to FIG. 1C and reference number 112) and that indicate the one or more relative depth measurements (e.g., of the one or more points of the second point cloud, respectively). That is, the metrology system may cause the third point cloud to include one or more points that are associated with the same horizontal and vertical values as the one or more points of the second point cloud, but that are associated with the relative depth measurements of the one or more points of the second point cloud (e.g., instead of the distance measurements of the one or more points of the second point cloud). As shown in FIG. 1D, the third point cloud is represented as comprising one or more points, shown as circles with diagonal patterning. The one or more points of the third point cloud shown in FIG. 1D have a same horizontal and vertical positioning as the one or more points of the second point cloud shown in FIG. 1C (shown as shaded circles) (e.g., to indicate that the one or more points of the third point cloud correspond to the one or more points of the second point cloud).

As shown in FIG. 1E, and by reference number 116, the metrology system may identify a particular relative depth measurement associated with a particular point of the third point cloud. For example, as shown in FIG. 1E, the metrology system may identify a particular relative depth measurement associated with a particular point, shown as a shaded circle, of the one or more points of the third point cloud that are shown as circles with diagonal patterning.

As shown by reference number 118, the metrology system may determine one or more other relative depth measurements from the particular point of the first point cloud to one or more other points of the second point cloud, respectively. That is, the particular distance measurement associated with the particular point of the first point cloud may be used as a reference distance measurement, and the metrology system may determine depth measurements of the one or more other points of the second point cloud relative to the reference depth measurement.

The one or more other points of the second point cloud may be associated with another sub-region of the region of the object (e.g., that is adjacent to the sub-region the region of the object described elsewhere herein). That is, the one or more other points of the second point cloud and the particular point of the third point cloud may be associated with adjacent sub-regions of the region of the object and are therefore neighboring points of the region of the object. For example, as shown in FIG. 1E, the particular point of the third point cloud, shown as a shaded circle, is associated with a particular area of the third point cloud (e.g., that is associated with the sub-region of the region of the object) and the one or more other points of the second point, shown as shaded circles, are associated with another area of the second point cloud (e.g., that is associated with the other sub-region of the region of the object).

In some implementations, the metrology system may determine that a first point of the one or more other points of the second point cloud that is closest to the particular point of the third point cloud (e.g., closest in a horizontal or a vertical direction) has a same relative depth, or substantially the same relative depth, as the particular point. The metrology system then may determine, based on the distance measurement associated with the first point (e.g., relative to a starting point of a fringe), the relative depth measurements of the other points of the one or more other points of the second point cloud. For example, the metrology system, for a particular other point, may subtract the distance measurement associated with the first point from the distance measurement associated with the other point to determine the relative depth measurement for the other point. In this way, the metrology system may determine the one or more other relative depth measurements of the one or more other points of the second point cloud, respectively.

As shown in FIG. 1F, and by reference number 120, the metrology system may update the third point cloud. In some implementations, the metrology system may update the third point cloud to include one or more other points that correspond to the one or more other points of the second point cloud (e.g., that are described herein with respect to FIG. 1E and reference number 118) and that indicate the one or more other relative depth measurements (e.g., of the one or more other points of the second point cloud, respectively). That is, the metrology system may cause the third point cloud to include one or more other points that are associated with the same horizontal and vertical values as the one or more other points of the second point cloud, but that are associated with the relative depth measurements of the one or more other points of the second point cloud (e.g., instead of the distance measurements of the one or more other points of the second point cloud). As shown in FIG. 1F, the one or more other points of the third point cloud, shown as circles with shading, have a same horizontal and vertical positioning as the one or more other points of the second point cloud shown in FIG. 1E (shown as shaded circles) (e.g., to indicate that the one or more other points of the third point cloud correspond to the one or more other points of the second point cloud).

In some implementations, the metrology system may perform one or more of the operations described herein in relation to FIGS. 1E-1F, and reference numbers 116-120, until the third point cloud includes a plurality of points that respectively correspond to the plurality of points of the second cloud. In this way, the third point cloud may be referred to as a “corrected” version of the second point cloud, where each point of the third point cloud indicates a relative depth measurement associated with a portion of the region of the object. Further, the relative depth measurements are associated with a known distance measurement (e.g., associated with the particular point of the first point cloud). So, the third point cloud provides an improved measurement precision as compared to the second point cloud by compensating for the shorter unambiguous range of the optical sensor of the metrology system that is associated with the second frequency.

In some implementations, the metrology system may perform one or more actions based on the third point cloud. As shown in FIG. 1F, and by reference number 122, the one or more actions may include causing generation and/or display of a comparison report based on the third point cloud. For example, the metrology system may generate, based on the third point cloud, a 3D model of the object. The metrology system then may generate, based on the 3D model of the object and 3D model information associated with the object (e.g. that was obtained by the metrology system, as elsewhere described herein), the comparison report associated with the object. The comparison report may indicate, for example, whether some or all of the 3D model of the object conforms to 3D model information associated with the object. In some implementations, the metrology system may cause the comparison report to be displayed (e.g., on a display screen of the metrology system). In this way, an operator of the metrology system may be visually informed when a geometry of the object differs from an expected geometry of the object. This enables the object to be further inspected (e.g., for depth inconsistencies) and/or repositioned for further measurement (e.g., to enable a more accurate measurement of the object).

As shown by reference number 124, the one or more actions may include sending the third point cloud and/or the comparison report to the server device. In this way, information related to measuring the object may be stored by the server device (e.g., in a data structure associated with the server device). This may enable the server device to perform quality control processes and/or identify patterns and trends associated with measuring the object and/or similar objects.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram of an example environment 200 in which systems and/or methods described herein may be implemented. As shown in FIG. 2, environment 200 may include a metrology system 210, a server device 220, and/or a network 230. Devices of environment 200 may interconnect via wired connections, wireless connections, or a combination of wired and wireless connections.

The metrology system 210 may include one or more devices capable of receiving, generating, storing, processing, and/or providing information as described elsewhere herein. The metrology system 210 may include one or more optimal sensors and may be configured to measure an object (e.g., using multiple frequencies), as described herein. The metrology system 210 may be configured to communicate with the server device 220 (e.g., via the network 230), such as to provide a point cloud, as described herein.

The server device 220 may include one or more devices capable of receiving, generating, storing, processing, and/or providing information, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with determining an optimal configuration for a metrology system. The device 300 may correspond to the metrology system 210 and/or the server device 220. In some implementations, the metrology system 210 and/or the server device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

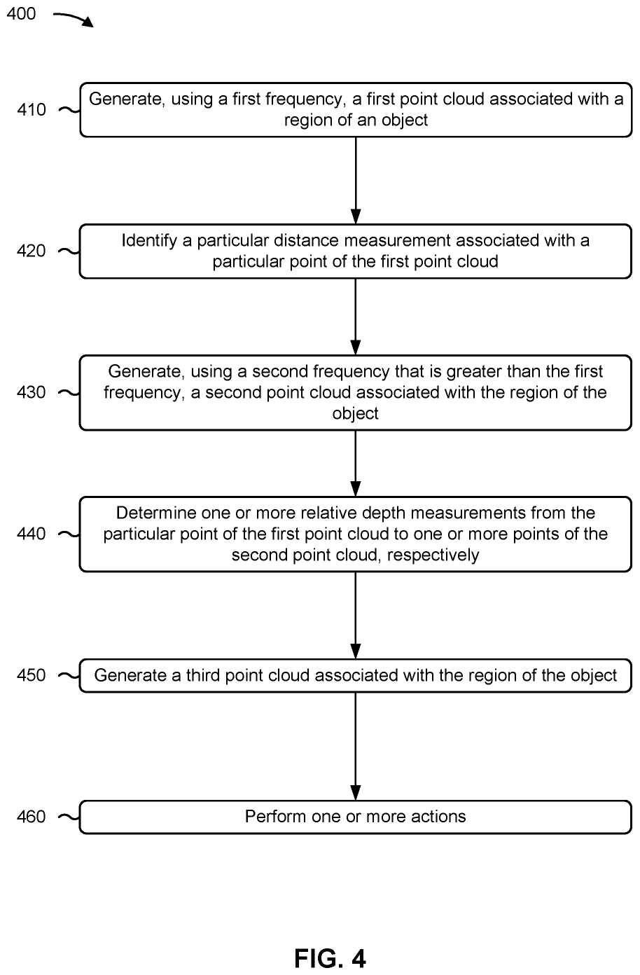

FIG. 4 is a flowchart of an example process 400 associated with facilitating generation of a point cloud with improved measurement precision. In some implementations, one or more process blocks of FIG. 4 are performed by a metrology system (e.g., metrology system 210). In some implementations, one or more process blocks of FIG. 4 are performed by another device or a group of devices separate from or including the metrology system, such as a server device (e.g., server device 220). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include generating, using a first frequency, a first point cloud associated with a region of an object (block 410). For example, the metrology system may generate, using a first frequency, a first point cloud associated with a region of an object, as described above. In some implementations, each point of the first point cloud indicates a distance measurement from a portion of the region of the object to an optical sensor of the metrology system.

As further shown in FIG. 4, process 400 may include identifying a particular distance measurement associated with a particular point of the first point cloud (block 420). For example, the metrology system may identify a particular distance measurement associated with a particular point of the first point cloud, as described above.

As further shown in FIG. 4, process 400 may include generating, using a second frequency that is greater than the first frequency, a second point cloud associated with the region of the object (block 430). For example, the metrology system may generate, using a second frequency that is greater than the first frequency, a second point cloud associated with the region of the object, as described above. In some implementations, each point of the second point cloud indicates a distance measurement from a portion of the region of the object to the optical sensor of the metrology system.

As further shown in FIG. 4, process 400 may include determining one or more relative depth measurements from the particular point of the first point cloud to one or more points of the second point cloud, respectively (block 440). For example, the metrology system may determine, based on the particular distance measurement associated with the particular point of the first point cloud, one or more relative depth measurements from the particular point of the first point cloud to one or more points of the second point cloud, respectively, as described above.

As further shown in FIG. 4, process 400 may include generating a third point cloud associated with the region of the object (block 450). For example, the metrology system may generate, based on the one or more relative depth measurements, a third point cloud associated with the region of the object, as described above. In some implementations, the metrology system may generate the third point cloud to include one or more points that correspond to the one or more points of the second point cloud and that indicate the one or more relative depth measurements, respectively.

As further shown in FIG. 4, process 400 may include performing one or more actions (block 460). For example, the metrology system may perform, based on the third point cloud, one or more actions, as described above.

Process 400 may include additional implementations, such as any single implementation or any combination of implementations described below and/or in connection with one or more other processes described elsewhere herein.

In a first implementation, the particular point of the first point cloud and the one or more points of the second point cloud are associated with a sub-region of the region of the object, and a number of the one or more points of the second point cloud is less than or equal to ten.

In a second implementation, alone or in combination with the first implementation, the optical sensor of the metrology system is a PB-MTCW optical sensor.

In a third implementation, alone or in combination with one or more of the first and second implementations, the first frequency is associated with a first unambiguous range of the optical sensor of the metrology system, the second frequency is associated with a second unambiguous range of the optical sensor of the metrology system, the particular point of the first point cloud and the one or more points of the second point cloud are associated with a sub-region of the region of the object, the sub-region of the region of the object is positioned within the first unambiguous range of the optical sensor of the metrology system, and an expected depth variation of the sub-region of the region of the object, as indicated by 3D model information associated with the object, is less than the second unambiguous range.

In a fourth implementation, alone or in combination with one or more of the first through third implementations, process 400 includes obtaining 3D model information associated with the object; identifying that the particular point of the first point cloud is associated with a sub-region of the region of the object; determining, based on the 3D model information, an expected depth variation of the sub-region of the region of the object; and selecting, as the second frequency, a frequency that is associated with an unambiguous range of the optical sensor of the metrology system that is greater than or equal to the expected depth variation of the sub-region of the object.

In a fifth implementation, alone or in combination with one or more of the first through fourth implementations, process 400 includes identifying a set of two or more adjacent points of the first point cloud, wherein a standard of deviation associated with respective distance measurements of the set of two or more adjacent points is less than or equal to respective standards of deviation of one or more other sets of two or more adjacent points of the first point cloud; and selecting, as the particular point of the first point cloud, a point from the set of two or more adjacent points of the first point cloud.

In a sixth implementation, alone or in combination with one or more of the first through fifth implementations, process 400 includes identifying a particular relative depth measurement associated with a particular point of the third point cloud; determining, based on the particular relative depth measurement associated with the particular point of the third point cloud, one or more other relative depth measurements from the particular point of the first point cloud to one or more other points of the second point cloud, respectively; and updating, based on the one or more other relative depth measurements, the third point cloud to include one or more other points that correspond to the one or more other points of the second point cloud and that indicate the one or more other relative depth measurements, respectively.

In a seventh implementation, alone or in combination with one or more of the first through sixth implementations, performing the one or more actions comprises generating, based on the third point cloud, a 3D model of the object, generating, based on the 3D model of the object and 3D model information associated with the object, a comparison report associated with the object, and causing the comparison report to be displayed on a display screen of the metrology system.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
generating, by a metrology system and using a first frequency, a first point cloud associated with a region of an object,
wherein each point of the first point cloud indicates a distance measurement from a portion of the region of the object to an optical sensor of the metrology system;
identifying, by the metrology system, a particular distance measurement associated with a particular point of the first point cloud;
generating, by the metrology system and using a second frequency that is greater than the first frequency, a second point cloud associated with the region of the object,
wherein each point of the second point cloud indicates a distance measurement from a portion of the region of the object to the optical sensor of the metrology system;
determining, by the metrology system and based on the particular distance measurement associated with the particular point of the first point cloud, one or more relative depth measurements from the particular point of the first point cloud to one or more points of the second point cloud, respectively;
generating, by the metrology system and based on the one or more relative depth measurements, a third point cloud associated with the region of the object to include one or more points that correspond to the one or more points of the second point cloud and that indicate the one or more relative depth measurements, respectively; and
performing, by the metrology system and based on the third point cloud, one or more actions.

2. The method of claim 1, wherein:
the particular point of the first point cloud and the one or more points of the second point cloud are associated with a sub-region of the region of the object; and
a number of the one or more points of the second point cloud is less than or equal to ten.

3. The method of claim 1, wherein the optical sensor of the metrology system is a phase-based multi-tone continuous wave (PB-MTCW) optical sensor.

4. The method of claim 1, wherein:
the first frequency is associated with a first unambiguous range of the optical sensor of the metrology system;
the second frequency is associated with a second unambiguous range of the optical sensor of the metrology system;
the particular point of the first point cloud and the one or more points of the second point cloud are associated with a sub-region of the region of the object;
the sub-region of the region of the object is positioned within the first unambiguous range of the optical sensor of the metrology system; and
an expected depth variation of the sub-region of the region of the object, as indicated by three-dimensional (3D) model information associated with the object, is less than the second unambiguous range.

5. The method of claim 1, further comprising:
obtaining three-dimensional (3D) model information associated with the object;
identifying that the particular point of the first point cloud is associated with a sub-region of the region of the object;
determining, based on the 3D model information, an expected depth variation of the sub-region of the region of the object; and
selecting, as the second frequency, a frequency that is associated with an unambiguous range of the optical sensor of the metrology system that is greater than or equal to the expected depth variation of the sub-region of the object.

6. The method of claim 1, further comprising:
identifying a set of two or more adjacent points of the first point cloud,
wherein a standard of deviation associated with respective distance measurements of the set of two or more adjacent points is less than or equal to respective standards of deviation of one or more other sets of two or more adjacent points of the first point cloud; and
selecting, as the particular point of the first point cloud, a point from the set of two or more adjacent points of the first point cloud.

7. The method of claim 1, further comprising:
identifying a particular relative depth measurement associated with a particular point of the third point cloud;
determining, based on the particular relative depth measurement associated with the particular point of the third point cloud, one or more other relative depth measurements from the particular point of the first point cloud to one or more other points of the second point cloud, respectively; and
updating, based on the one or more other relative depth measurements, the third point cloud to include one or more other points that correspond to the one or more other points of the second point cloud and that indicate the one or more other relative depth measurements, respectively.

8. The method of claim 1, wherein performing the one or more actions comprises:
generating, based on the third point cloud, a three-dimensional (3D) model of the object;
generating, based on the 3D model of the object and 3D model information associated with the object, a comparison report associated with the object; and
causing the comparison report to be displayed on a display screen of the metrology system.

9. A metrology system, comprising:
one or more memories; and
one or more processors, coupled to the one or more memories, configured to:
generate, based on the metrology system using a first frequency, a first point cloud associated with a region of an object;
identify a particular distance measurement associated with a particular point of the first point cloud;
generate, based on the metrology system using a second frequency that is greater than the first frequency, a second point cloud associated with the region of the object,
determine, based on the particular distance measurement associated with the particular point of the first point cloud, one or more relative depth measurements from the particular point of the first point cloud to one or more points of the second point cloud, respectively; and
generate, based on the one or more relative depth measurements, a third point cloud associated with the region of the object to include one or more points that correspond to the one or more points of the second point cloud and that indicate the one or more relative depth measurements, respectively.

10. The metrology system of claim Error! Reference source not found., wherein:
the particular point of the first point cloud and the one or more points of the second point cloud are associated with a sub-region of the region of the object.

11. The metrology system of claim Error! Reference source not found., wherein:
the particular point of the first point cloud and the one or more points of the second point cloud are associated with a sub-region of the region of the object; and
an expected depth variation of the sub-region of the region of the object, as indicated by three-dimensional (3D) model information associated with the object, is less than an unambiguous range of an optical sensor of the metrology system that is associated with the second frequency.

12. The metrology system of claim Error! Reference source not found., wherein the one or more processors are further configured to:
identify that the particular point of the first point cloud is associated with a sub-region of the region of the object;
determine, based on three-dimensional (3D) model information associated with the object, an expected depth variation of the sub-region of the region of the object; and
select, as the second frequency, a frequency that is associated with an unambiguous range of an optical sensor of the metrology system that is greater than or equal to the expected depth variation of the sub-region of the object.

13. The metrology system of claim Error! Reference source not found., wherein the one or more processors are further configured to:
identify a particular relative depth measurement associated with a particular point of the third point cloud;
determine, based on the particular relative depth measurement associated with the particular point of the third point cloud, one or more other relative depth measurements from the particular point of the first point cloud to one or more other points of the second point cloud, respectively; and
update, based on the one or more other relative depth measurements, the third point cloud to include one or more other points that correspond to the one or more other points of the second point cloud and that indicate the one or more other relative depth measurements, respectively.

14. The metrology system of claim Error! Reference source not found., wherein the one or more processors are further configured to:
generate, based on the third point cloud and three-dimensional (3D) model information associated with the object, a comparison report associated with the object; and
cause the comparison report to be displayed on a display screen of the metrology system.

15. A non-transitory computer-readable medium storing a set of instructions, the set of instructions comprising:
one or more instructions that, when executed by one or more processors of a metrology system, cause the metrology system to:
generate, based on the metrology system using a first frequency, a first point cloud associated with a region of an object,
generate, based on the metrology system using a second frequency that is greater than the first frequency, a second point cloud associated with the region of the object,
determine, based on a particular distance measurement associated with a particular point of the first point cloud, one or more relative depth measurements from the particular point of the first point cloud to one or more points of the second point cloud, respectively; and
generate, based on the one or more relative depth measurements, a third point cloud associated with the region of the object to include one or more points that correspond to the one or more points of the second point cloud and that indicate the one or more relative depth measurements, respectively.

16. The non-transitory computer-readable medium of claim Error! Reference source not found., wherein:
a number of the one or more points of the second point cloud is less than or equal to ten.

17. The non-transitory computer-readable medium of claim Error! Reference source not found., wherein:
the particular point of the first point cloud and the one or more points of the second point cloud are associated with a sub-region of the region of the object; and
an expected depth variation of the sub-region of the region of the object is less than an unambiguous range of an optical sensor of the metrology system that is associated with the second frequency.

18. The non-transitory computer-readable medium of claim Error! Reference source not found., wherein the one or more instructions further cause the metrology system to:
identify that the particular point of the first point cloud is associated with a sub-region of the region of the object;
determine an expected depth variation of the sub-region of the region of the object; and
select, as the second frequency, a frequency that is associated with an unambiguous range of an optical sensor of the metrology system that is greater than or equal to the expected depth variation of the sub-region of the object.

19. The non-transitory computer-readable medium of claim Error! Reference source not found., wherein the one or more instructions further cause the metrology system to:
identify a particular relative depth measurement associated with a particular point of the third point cloud;
determine, based on the particular relative depth measurement associated with the particular point of the third point cloud, one or more other relative depth measurements from the particular point of the first point cloud to one or more other points of the second point cloud, respectively; and
update, based on the one or more other relative depth measurements, the third point cloud to include one or more other points that correspond to the one or more other points of the second point cloud and that indicate the one or more other relative depth measurements, respectively.

20. The non-transitory computer-readable medium of claim Error! Reference source not found., wherein the one or more instructions cause the metrology system further to:
generate, based on the third point cloud, a comparison report associated with the object; and
cause the comparison report to be displayed on a display screen of the metrology system.
